(19) United States
(12) Patent Application Publication
(10) Pub. No.: US 2008/0246776 A1
(43) Pub. Date: Oct. 9, 2008

(54) Motion Estimation and Compensation of Image Sequences

(75) Inventors: Kirsten Meetz, Hamburg (DE); Daniel Bystrov, Hamburg (DE); Vladimir Pekar, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/089,715

(22) PCT Filed: Oct. 16, 2006
(86) PCT No.: PCT/IB06/53784

§ 371 Date: Apr. 10, 2008

(30) Foreign Application Priority Data
Oct. 17, 2005 (EP) 05109613.9

(51) Int. Cl. G09G 5/00; G06K 9/00

(52) U.S. Cl. 345/634; 382/107

(57) ABSTRACT

The invention relates to a method, a system and a computer program for dynamic imaging of a moving object. First, motion between the elements of common portions of images Iₘ(t), Iₘ₊₁(t) is computed. At step 1 motion compensation the said elements is performed, using a suitable transformation. Assuming that Iₘ₊₁ is the image that has to be transformed, its motion from m to m+1 is compensated applying the inverse motion estimation Formula (I) resulting in the reformatted image Formula (II) at position m. At step 2 grey value interpolation is performed, based on image Iₘ and the transformed image I′ₘ₊₁ resulting in j interpolated images Formula (III) with o<i≦j. At step 3 spatial interpolation is carried out yielding a series of images for dynamic imaging of the moving object. The spatial interpolation is calculated placing the images Formula (III) at position i resulting in j images Formula (IV) with 0<i≦j and the transformation's weighting factor w=i/j.

The invention relates to a method for dynamic imaging of a moving object, said method comprising the steps of:
accessing images of the moving object, said images comprising elements with respective intensities representative of the object;
computing motion between the elements of at least common portions of successive images.

The invention further relates to a system for enabling dynamic imaging of a moving object.

The invention still further relates to a computer program for dynamic imaging of a moving object.

An embodiment of the method as is set forth in the opening paragraph is known from US 2002/0180761 A1. The known method is arranged for a consecutive displaying of images, notably medical images, which are temporally spaced in accordance with a suitable data acquisition mode. The known method is arranged to compensate for a jerky motion of an imaged object in the thus obtained dynamic imaging of consecutive images. For this purpose, in the known method a dense motion vector fields between adjacent image frames of the original set of images is calculated. The dense motion fields are then used to generate interpolation images between the images of the original dataset. The interpolated images are then interlaced with the original images for purposes of smoothing the jerky motion visible in the dynamic imaging mode.

It is a disadvantage of the known method that it provides a mere multiplication of the original dataset based on a calculation of the dense vector motion. For objects with a substantially irregular motion pattern the known method may be inadequate, and rather slow due to required substantial computing resources for carrying out the calculus. Moreover, it may not be enough to just multiplex a number of images for removing the jerky motion in the dynamic imaging mode.

It is an object of the invention to provide a method for dynamic imaging of a moving object whereby the jerky motion is substantially removed even for complex motion pattern of the object.

To this end the method according to the invention further comprises the steps of:
performing motion compensation for the said elements based on the computed motion;
computing further respective intensities of the elements based on the motion compensation; computing spatial interpolation between the said portions of successive images yielding a series of images for dynamic imaging of the moving object.

Medical units, like magnetic resonance imaging apparatus, X-ray unit, computer tomography unit, etc. are often used for acquiring time series of “n” 3-dimensional (3D) images, which provides a 4-dimensional (4D) examination that can be used for kinematic imaging of a movable object, notably a joint. However, slice-by-slice viewing of the 4D images is cumbersome, and does not allow estimating the movement. Simply presenting slice data in a cine-loop will be compromised by “jerks” between frames, which hamper visual analysis of the movement. These jerks are caused by a limited number of acquired 3D volumes that do not cover the motion completely. However, for clinical applications it is required to produce smooth visualization of the images volume in a substantially fast way, yet presenting accurately derived images for clinical assessment.

The invention provide such method, which is robust and accurate on one hand, and does not require substantial calculus and computing time, contrary to the known method, on the other hand. The technical measure of the invention is based on the insight that in order to compensate for motion between images a suitable interpolation of respective 3D volumes can be carried out thus overcoming the limitations of the prior art. It is understood that linear interpolation as it is commonly used for static images will lead to shadowing artifacts caused by the movement. The technical measure of the invention is based on the further insight that for kinematic images a motion interpolation approach is suitable, which is based on the estimation of the motion between subsequent 3D images. Hereby shadowing artifacts are eliminated.

The method according to the invention, thereby comprises the following steps:

### Motion Estimation

Given a time series of n 3D images Iₜ acquired at time t ε {1,2, . . . k) the motion from Iₘ to Iₘ₊₁ with 0<m<k is estimated e.g. by elastic image registration, like per se known method of B-Splines, or, for example, a per se known method of adaptive gaussian forces.

### Motion Compensation

In order to perform a motion interpolation the subsequent images Iₘ and Iₘ₊₁ have to be placed at a common (target) position n with m<n<m+1 beforehand. For each position n two transformations have to be applied, which are based on the motion estimation M_{m→n}(Iₘ) and M_{n→m+1}⁻¹(Iₘ₊₁).

More efficiently, only one of the images is transformed, saving computation time even further. Assuming that Iₘ₊₁ is the image that has to be transformed, its motion from m to m+1 is compensated applying the inverse motion estimation M_{m→m+1}⁻¹ resulting in the reformatted image I′ₘ₊₁=M_{m→m+1}⁻¹(Iₘ₊₁) at position m.

### Grey Value Interpolation

It is a common practice to present the intensity of a picture element in term of grey value. In the method according to the invention a grey value interpolation is calculated of image Iₘ and the transformed image I′ₘ₊₁ resulting in j interpolated images I′_{m,m+1}ⁱ with 0<i≦j. Preferably, a linear grey value interpolation is used, which is given by

$${I}_{m , m + 1}^{′ i } = \frac{( j - i ) \times {I}_{m} + i \times {I}_{m + 1}^{′ }}{2 j} .$$

### Spatial Interpolation

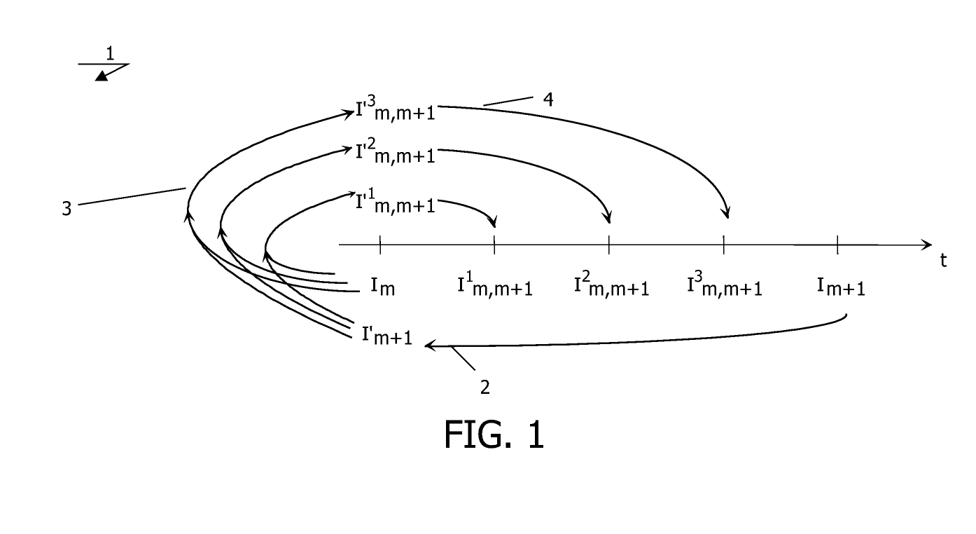

Subsequently, the spatial interpolation is calculated placing the images I′_{m,m+1}ⁱ at position i resulting in j images I_{m,m+1}ⁱ=M_{m→m+1,ω}(I′_{m,m+1}) with 0<i≦j and the transformation's weighting factor ω=i/j, which is schematically shown in FIG. 1.

It is noted that although the method of the invention is described with reference to a four-dimensional dataset, it can also be succefully applied to other time-series, e.g. 2D+t. It is further noted that the method according to the invention is not limited to any particular data acquisition system and can be successfully applied to a great variety of imaging modalities that provide time series, for example MR, CT, US, PET, SPECT, or any combination thereof. It is further noted that the motion can also be estimated by means of a suitable segmentation, notably using a model-based segmentation of images, or by means of a suitable registration of, for example, the surface of segmented anatomical objects, or based on anatomical or fiducial markers, identifiable within images. Non-linear as well as linear interpolation approaches can be used for grey-value and motion interpolation. Grey-value-based and/or motion-based weighting can enhance the motion interpolation.

The system according to the invention comprises:
an input for:

accessing images of the moving object, said images comprising elements with respective intensities representative of the object;
a processor for:

computing motion between the elements of at least common portions of successive images;

performing motion compensation for the said elements based on the computed motion;

computing further respective intensities of the elements based on the motion compensation;

computing spatial interpolation between the said portions of successive images yielding a series of images for dynamic imaging of the moving object.

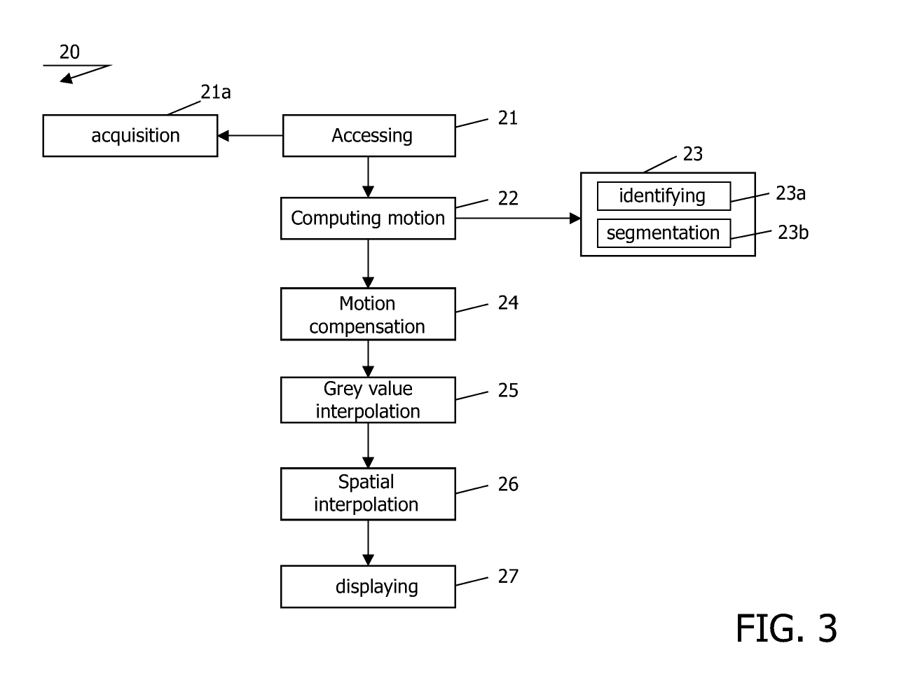

Preferably, the system according to the invention further comprises a display unit for displaying the result of the dynamic imaging of the moving object. Still preferably, the system according to the invention still further comprises a data acquisition unit for acquiring the images of the moving object. Examples of suitable data acquisition units comprise a magnetic resonance unit (MR), a computer tomography unit (CT), an ultra-sound unit (US), a positron-emitting device (PET), a single photon emitting computer tomography (SPECT), or any combination thereof. Further advantageous embodiments of the system according to the invention will be discussed with reference to FIG. 3.

The computer program according to the invention comprises the following instructions for causing the processor to carry out the following steps:
accessing images of the moving object, said images comprising elements with respective intensities representative of the object;
computing motion between the elements of at least common portions of successive images;
performing motion compensation for the said elements based on the computed motion;
computing further respective intensities of the elements based on the motion compensation;
computing spatial interpolation between the said portions of successive images yielding a series of images for dynamic imaging of the moving object.

Preferably, the computer program according to the invention further comprises an instruction for causing the processor to carry out the step of visualizing the results of dynamic imaging of the moving object on a display. The operation of the computer program according to the invention will be discussed in more detail with reference to FIG. 3.

FIG. 1 presents in a schematic way an embodiment of the method according to the invention.

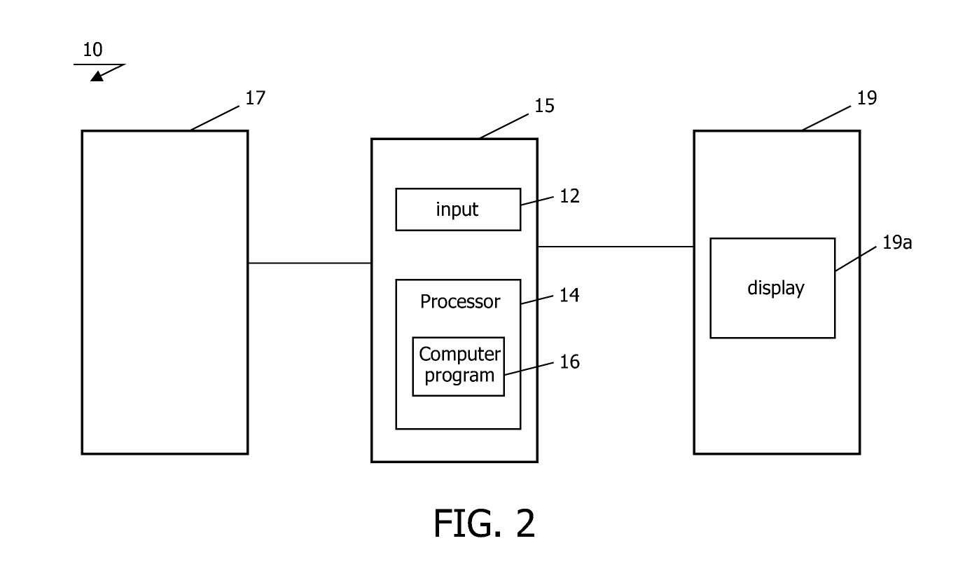

FIG. 2 presents in a schematic way an embodiment of a system according to the invention.

FIG. 3 presents in a schematic way an embodiment of a flow-chart of the computer program according to the invention.

FIG. 1 presents in a schematic way an embodiment of the method according to the invention. At a preparatory step (not shown) images of a moving object I(t), for example a joint, are accessed and motion between the elements of at least common portions of successive images Iₘ(t), Iₘ₊₁(t) is computed. Given a time series of, for example, n 3D images Iₜ acquired at time t ε {1,2, . . . k) the motion from Iₘ to Iₘ₊₁ with 0<m<k is preferably estimated e.g. by elastic image registration, like per se known method of B-splines, or, for example, a per se known method of adaptive gaussian forces. It is noted that for implementation of the method it is not strictly required to compute the motion between the nearest neighbours in the temporal sequence, however, for data acquisition modes with a substantial time interval between successive images, it is preferable to compute the motion between each successive pair of images Iₘ(t), Iₘ₊₁(t). Also, for the purpose of calculating motion results of segmentation, registration of a surface or identification of landmarks or fiducial markers can be used. At step 1 of the method according to the invention motion compensation is performed for the said elements based on the computed motion. Within the terms of the present invention the element is understood as either a pixel, an image area, a voxel, or a volume element. In order to perform a motion interpolation the subsequent images Iₘ and Iₘ₊₁ have to be placed at a common (target) position n with m<n<m+1 beforehand. For each position n two transformations have to be applied, which are based on the motion estimation M_{m→v.}(Iₘ) and M_{n→m+1}⁻¹(Iₘ₊₁).

More efficiently, only one of the images is transformed, saving computation time even further. Assuming that Iₘ₊₁ is the image that has to be transformed, its motion from m to m+1 is compensated applying the inverse motion estimation M_{m→m+1}⁻¹ resulting in the reformatted image I′_{m|1}=M_{m>m|1}⁻¹(Iₘ₊₁) at position m.

At step 2 of the method according to the invention grey value interpolation is performed, as it is a common practice to present the intensity of a picture element in terms of grey value. In the method according to the invention a grey value interpolation is calculated of image Iₘ and the transformed image I′ₘ₊₁ resulting in j interpolated images I′_{m,m+1}⁻¹ with 0<i≦j. Preferably, a linear grey value interpolation is used, which is given by

$${I}_{m , m + 1}^{′ i } = \frac{( j - i ) \times {I}_{m} + i \times {I}_{m + 1}^{′ }}{2 j} .$$

However, other approaches, like non-linear interpolation are suitable for this purpose as well.

Finally, at step 3 of the method according to the invention spatial interpolation is carried out yielding a series of images for dynamic imaging of the moving object. The spatial interpolation is calculated placing the images I′_{m,m+1}ⁱ at position i resulting in j images I_{m,m+1}ⁱ=M_{m→m+1,ω}(I′_{m,m+1}ⁱ) with 0<i≦j and the transformation's weighting factor ω=i/j.

FIG. 2 presents in a schematic way an embodiment of a system according to the invention. The system 10 according to the invention comprises a computer 15 with the input 15 arranged to access images of the moving object (not shown), said images comprising elements with respective intensities representative of the object. It is a common practice to represent respective image intensities as grey values. The system 20 may further comprise a suitable data acquisition unit 17, for example a magnetic resonance unit (MR), a computer tomography unit (CT), an ultra-sound unit (US), a positron-emitting device (PET), a single photon emitting computer tomography (SPECT), or any combination thereof. The computer 15 of the system according to the invention further comprises a processor 14 arranged to compute motion between the elements of at least common portions of successive images, to perform motion compensation for the said elements based on the computed motion, to compute further respective intensities of the elements (grey values) based on the motion compensation and to compute spatial interpolation between the said portions of successive images yielding a series of images for dynamic imaging of the moving object. For this steps the method of the invention as is described with reference to FIG. 1 is used. Preferably, the operation of the computer 15 is controlled by a computer program 16 comprising instructions for causing the processor to carry out the said steps. A flow-chart of the computer program according to the invention will be discussed with reference to FIG. 3. Preferably, the system 20 further comprises a display unit 19 arranged to display the thus obtained results of the dynamic imaging of the moving object. Methods of imaging are per se known in the art and will not be explained here in detail. It is preferable to use a fully automatic viewing mode, for example a cine-loop to enable an accurate data assessment by a suitable user.

FIG. 3 presents in a schematic way an embodiment of a flow-chart of the computer program according to the invention. The computer program 20 according to the invention comprises instructions for causing the processor to carry out the step 21 of accessing images of the moving object, said images comprising elements with respective intensities representative of the object. Preferably, the computer program further comprises an instruction for causing the processor to initiate the step 21a of data acquisition by means of a suitable computer-controllable data acquisition unit. Examples of suitable data acquisition units comprise, for example, a magnetic resonance unit (MR), a computer tomography unit (CT), an ultra-sound unit (US), a positron-emitting device (PET), a single photon emitting computer tomography (SPECT), or any combination thereof.

The computer program 20 according to the invention further comprises the instruction causing the processor to compute motion between the elements of at least common portions of successive images using suitable computing algorithms. Given a time series of n 3D images It acquired at time t ε {1,2, . . . k) the motion from Iₘ to Iₘ₊₁ with 0<m<k is advantageously estimated using, for example, elastic image registration, like per se known method of B-Splines, or, for example, a per se known method of adaptive gaussian forces. Alternatively, the computer program 20 may comprise further instruction 23 for identifying the respective common portions of interest within said images, based, for example, on results of suitable data segmentation.

The computer program according to the invention further comprises the instruction 24 for causing the processor to perform motion compensation for picture elements based on the computed motion. In order to perform a motion interpolation the subsequent images Iₘ and Iₘ₊₁ have to be placed at a common (target) position n with m<n<m+1 beforehand. For each position n two transformations have to be applied, which are based on the motion estimation M_{m→n}(Iₘ) and M_{n→m+1}⁻¹(Iₘ₊₁) More efficiently, only one of the images is transformed, saving computation time even further. Assuming that Iₘ₊₁ is the image that has to be transformed, its motion from m to m+1 is compensated applying the inverse motion estimation M_{m→m+1}⁻¹ resulting in the reformatted image I′ₘ₊₁=M_{m→m+1}¹(Iₘ₊₁) at position m.

The instruction 25 of the computer program causes the processor to compute further respective of the elements based on the motion compensation. It is a common practice to present the intensity of a picture element in term of grey value. In the method according to the invention a grey value interpolation is calculated of image Iₘ and the transformed image I′ₘ₊₁ resulting in j interpolated images I′_{m,m+1}ⁱ with 0<i≦j. Preferably, a linear grey value interpolation is used, which is given by

$${I}_{m , m + 1}^{′ i } = \frac{( j - i ) \times {I}_{m} + i \times {I}_{m + 1}^{′ }}{2 j} .$$

Alternatively, a non-linear interpolation can be used.

The instruction 26 causes the processor to compute spatial interpolation between the said portions of successive images yielding a series of images for dynamic imaging of the moving object, which can be advantageously displayed on a suitable display unit in response to the instruction 27 of the computer program 20 according to the invention. As the result of the spatial interpolation the images I′_{m,m+1}ⁱ are placed at position i resulting in j images I_{m,m+1}¹=M_{m→m+1,ω}(I′_{m,m+1}ⁱ) with 0<i≦j, whereby a suitable transformation's weighting factor ω=i/j is used.

1. A method for dynamic imaging of a moving object, said method comprising the steps of:
accessing images of the moving object, said images comprising elements with respective intensities representative of the object;
computing motion between the elements of at least common portions of successive images;
performing motion compensation for the said elements based on the computed motion;
computing further respective intensities of the elements based on the motion compensation;
computing spatial interpolation between the said portions of successive images yielding a series of images for dynamic imaging of the moving object.

2. A method according to claim 1, whereby motion is computed based on results of segmentation of the images.

3. A method according to claim 1, whereby motion is computed based on results of registration of a portion of the objects.

4. A method according to claim 1, whereby motion is computed based on identifiable markers in the images.

5. A method according to claim 1, whereby the method further comprises a step of visualizing the results of dynamic imaging of the moving object on a display.

6. A system for enabling dynamic imaging of a moving object, said system comprising:
an input for:
accessing images of the moving object, said images comprising elements with respective intensities representative of the object;
a processor for:
computing motion between the elements of at least common portions of successive images;
performing motion compensation for the said elements based on the computed motion;
computing further respective intensities of the elements based on the motion compensation;
computing spatial interpolation between the said portions of successive images yielding a series of images for dynamic imaging of the moving object.

7. A system according to claim 6, whereby the system further comprises a display for displaying results of dynamic imaging of the moving object.

8. A system according to claim 6, whereby the system further comprises a data acquisition unit for acquiring the images.

9. A computer program for causing a processor to carry out the following steps:
accessing images of the moving object, said images comprising elements with respective intensities representative of the object;
computing motion between the elements of at least common portions of successive images;
performing motion compensation for the said elements based on the computed motion;
computing further respective intensities of the elements based on the motion compensation;
computing spatial interpolation between the said portions of successive images yielding a series of images for dynamic imaging of the moving object.

10. A computer program according to claim 9, further comprising an instruction for causing the processor to carry out the step of visualizing the results of dynamic imaging of the moving object on a display.
